(19) United States
(12) Patent Application Publication
(10) Pub. No.: US 2024/0402531 A1
(43) Pub. Date: Dec. 5, 2024

(54) LIQUID CRYSTAL DISPLAY DEVICE

(71) Applicant: Shanghai Tianma Micro-Electronics Co., Ltd., Shanghai (CN)

(72) Inventor: Tetsuroh ASAKURA, Kanagawa (JP)

(73) Assignee: Shanghai Tianma Micro-Electronics Co., Ltd., Shanghai (CN)

(21) Appl. No.: 18/731,692

(22) Filed: Jun. 3, 2024

(30) Foreign Application Priority Data
Jun. 1, 2023 (JP) 2023-090744

(51) Int. Cl. G02F 1/1335; G02F 1/1333

(52) U.S. Cl. CPC G02F 1/133512; G02F 1/13336; G02F 1/133528

(57) ABSTRACT

A liquid crystal display device includes a juxtaposed plurality of liquid crystal display panels, and a back light that emits light on the plurality of liquid crystal display panels. Each of the plurality of liquid crystal display panels includes, on a side surface opposing a side surface of the liquid crystal display panel adjacent thereto, a light shielding film that blocks the light from the back light.

### CROSS-REFERENCE TO RELATED APPLICATIONS

This application claims the benefit of Japanese Patent Application No. 2023-090744, filed on Jun. 1, 2023, the entire disclosure of which is incorporated by reference herein.

### FIELD OF THE INVENTION

This application relates generally to a liquid crystal display device.

### BACKGROUND OF THE INVENTION

In the related art, liquid crystal display devices in which a plurality of liquid crystal display panels are arranged to configure one screen are known. For example, Unexamined Japanese Patent Application Publication No. 2017-009770 describes a liquid crystal display device including a first light shield that covers a frame region on a front surface side of a joint portion of adjacent liquid crystal display panels, and a light shielding plate that is disposed in a gap formed between the adjacent liquid crystal display panels.

In the liquid crystal display device of Unexamined Japanese Patent Application Publication No. 2017-009770, light leakage is suppressed by the first light shield that covers the frame region and the light shielding plate disposed in the gap. In the liquid crystal display device of Unexamined Japanese Patent Application Publication No. 2017-009770, the spacing of the liquid crystal display panels cannot be sufficiently narrowed due to the light shielding plate being disposed between the liquid crystal display panels. Moreover, the liquid crystal display panels and the light shielding plate must be adhered to each other using an adhesive.

### SUMMARY OF THE INVENTION

A liquid crystal display device of the present disclosure includes:
a juxtaposed plurality of liquid crystal display panels; and
a back light that emits light on the plurality of liquid crystal display panels, wherein
each of the plurality of liquid crystal display panels includes, on a side surface opposing a side surface of the liquid crystal display panel adjacent thereto, a light shielding film that blocks the light from the back light.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a plan view illustrating a liquid crystal display device according to Embodiment 1;

FIG. 2 is a cross-sectional view of the liquid crystal display device illustrated in FIG. 1, taken along line A-A;

FIG. 3 is a schematic view illustrating a cross-section of a liquid crystal display panel according to Embodiment 1;

FIG. 4 is a schematic view illustrating a side surface of the liquid crystal display panel according to Embodiment 1;

FIG. 5 is a schematic view for explaining light blocked by a light shielding film, according to Embodiment 1;

FIG. 6 is a schematic view for explaining a forming method of the light shielding film according to Embodiment 1;

FIG. 7 is a schematic view illustrating a cross-section of a liquid crystal display device according to Embodiment 2;

FIG. 8 is a schematic view illustrating a cross-section of the liquid crystal display panel and a joint filler according to Embodiment 2;

FIG. 9 is a schematic view illustrating a cross-section of a liquid crystal display panel and a joint filler according to Embodiment 3;

FIG. 10 is a schematic view illustrating a liquid crystal display panel according to a modified example; and

FIG. 11 is a schematic view illustrating a cross-section of a liquid crystal display panel and a joint filler according to a modified example.

### DETAILED DESCRIPTION OF THE INVENTION

Hereinafter, a liquid crystal display device according to various embodiments is described while referencing the drawings.

### Embodiment 1

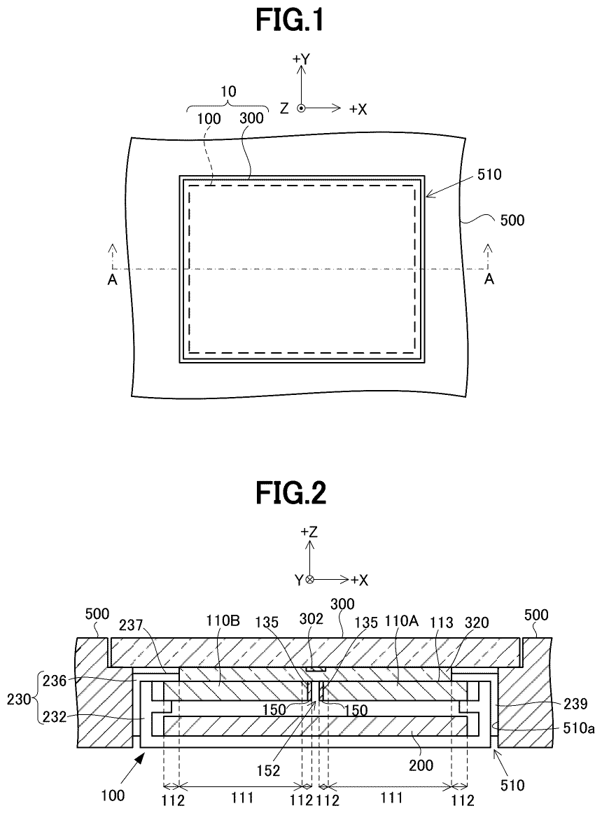

A liquid crystal display device 10 according to the present embodiment is described while referencing FIGS. 1 to 6. In one example, the liquid crystal display device 10 is mounted on a vehicle. In the present embodiment and the following embodiments, a description is given of an example in which the liquid crystal display device 10 is mounted on a vehicle. The passenger of the vehicle corresponds to a user (observer).

As illustrated in FIGS. 1 and 2, the liquid crystal display device 10 is disposed on an opening 510 of an instrument panel 500 of a vehicle. In one example, the instrument panel 500 is formed from a resin. Note that, in the present specification, to facilitate comprehension, a description is given in which, in FIG. 1, the longitudinal direction (the right direction on paper) of the liquid crystal display device 10 is referred to as the “+X direction”, the transverse direction (the up direction on paper) is referred to as the “+Y direction”, and the direction perpendicular to the +X direction and the +Y direction (the front direction on paper, the passenger side) is referred to as the “+Z direction.” Additionally, the hatching of a housing 230 is omitted in FIG. 2.

The liquid crystal display device 10 includes a display 100 and a protector 300. The display 100 displays text, images, and the like. The protector 300 protects liquid crystal display panels 110A, 110B, described later, of the display 100.

The display 100 of the liquid crystal display device 10 includes two liquid crystal display panels 110A, 110B, a back light 200, and a housing 230. The liquid crystal display panels 110A, 110B display text, images, and the like. The back light 200 is a light source of the liquid crystal display panels 110A, 110B. The housing 230 accommodates the liquid crystal display panels 110A, 110B and the back light 200.

The liquid crystal display panels 110A, 110B of the display 100 are juxtaposed within the XY plane. In one example, the liquid crystal display panels 110A, 110B are implemented as known transmission type transverse electric field liquid crystal display panels. The liquid crystal display panels 110A, 110B are active matrix driven by thin film transistors (TFT). The liquid crystal display panels 110A, 110B modulate the light from the back light 200 to display text, images, and the like. In one example, the liquid crystal display panel 110A is used as a center information display (CID). In one example, the liquid crystal display panel 110B is used as an instrument cluster display. Additionally, a configuration is possible in which the liquid crystal display panel 110A and the liquid crystal display panel 110B are used as one CID or as one instrument cluster display.

The liquid crystal display panels 110A, 110B include a display region 111 and a periphery 112. The display region 111 is a region in which pixels are arranged in a matrix. The display region 111 is capable of displaying text, images, and the like. The periphery 112 is a region in which wirings, drive circuits, and the like are disposed.

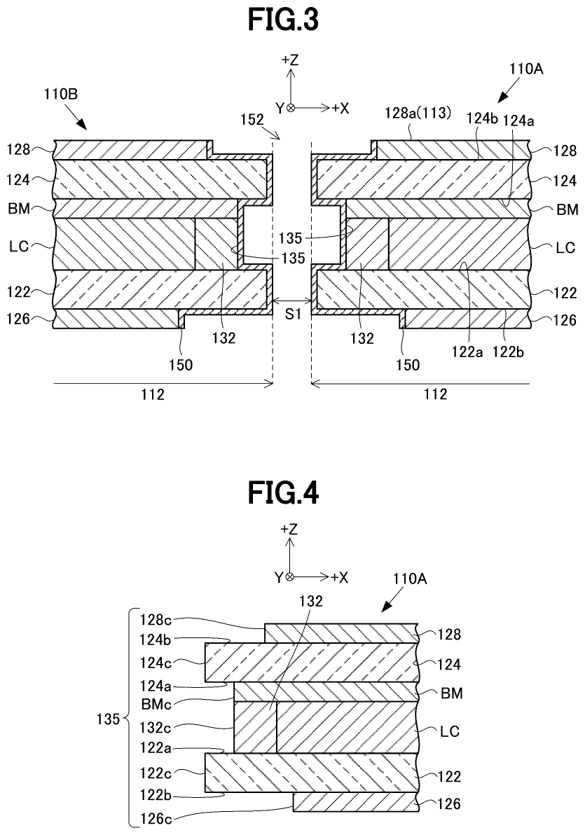

As illustrated in FIG. 3, each of the liquid crystal display panels 110A, 110B includes a TFT substrate 122, a counter substrate 124, a liquid crystal LC, an incident side polarizing plate 126, and an exit side polarizing plate 128. Furthermore, as illustrated in FIGS. 2 and 3, each of the liquid crystal display panels 110A, 110B includes a light shielding film 150.

In one example, the TFT substrate 122 is implemented as a glass substrate. The TFT substrate 122 is positioned on the −Z side. TFTs for selecting pixels, common electrodes, pixel electrodes, a drive circuit, an alignment film for aligning the liquid crystal LC, and the like (all not illustrated in the drawings) are provided on a main surface 122a on the liquid crystal LC side of the TFT substrate 122. The incident side polarizing plate 126 is provided on a main surface 122b of the TFT substrate 122, on the side opposite the main surface 122a.

The counter substrate 124 is positioned on the +Z side, and opposes the TFT substrate 122. The counter substrate 124 is affixed to the TFT substrate 122 by a sealing material 132. In one example, the counter substrate 124 is implemented as a glass substrate. A color filter (not illustrated in the drawings), a black matrix BM, an alignment film that aligns the liquid crystal LC, and the like are provided on a main surface 124a on the liquid crystal LC side of the counter substrate 124. The exit side polarizing plate 128 is provided on a main surface 124b of the counter substrate 124, on the side opposite the main surface 124a.

The liquid crystal LC is sandwiched between the TFT substrate 122 and the counter substrate 124. In one example, the liquid crystal LC is implemented as a positive-type nematic liquid crystal. The liquid crystal LC is initially aligned, by the alignment film, in a direction parallel to the main surface 122a of the TFT substrate 122. Additionally, the liquid crystal LC rotates, as a result of applying voltage, in a plane parallel to the main surface 122a of the TFT substrate 122.

The incident side polarizing plate 126 is provided on the main surface 122b of the TFT substrate 122. The exit side polarizing plate 128 is provided on the main surface 124b of the counter substrate 124. One transmission axis of the transmission axis of the incident side polarizing plate 126 and the transmission axis of the exit side polarizing plate 128 is arranged parallel to the initial alignment direction of the liquid crystal LC. The transmission axis of the incident side polarizing plate 126 and the transmission axis of the exit side polarizing plate 128 are orthogonal to each other. In the present embodiment, a main surface 128a on the +Z side of the exit side polarizing plate 128 corresponds to a display surface 113 of the liquid crystal display panels 110A, 110B.

As illustrated in FIGS. 2 and 3, the light shielding film 150 is provided on each side surface 135, that oppose each other, of the liquid crystal display panel 110A and the liquid crystal display panel 110B. In the present embodiment, the side surface 135 of the liquid crystal display panel 110A is the side surface of an entirety of the liquid crystal display panel 110A. As illustrated in FIG. 4, the side surface 135 includes not only a side surface 122c of the TFT substrate 122, a side surface 124c of the counter substrate 124, a side surface 126c of the incident side polarizing plate 126, a side surface 128c of the exit side polarizing plate 128, a side surface 132c of the sealing material 132, and a side surface BMc of the black matrix BM, but also the main surfaces 122a, 122b of the TFT substrate 122 and the main surfaces 124a, 124b of the counter substrate 124 exposed at the side of the liquid crystal display panel 110A. The side surface 135 of the liquid crystal display panel 110B is the same as the side surface 135 of the liquid crystal display panel 110A. In the present embodiment, the light shielding film 150 covers an entirety of the side surfaces 135 of the liquid crystal display panel 110A and the liquid crystal display panel 110B.

Note that, to facilitate comprehension, the light shielding film 150 is omitted from FIG. 4. Additionally, a member is not disposed between the light shielding film 150 of the liquid crystal display panel 110A and the light shielding film 150 of the liquid crystal display panel 110B. A gap 152 is provided between the light shielding film 150 of the liquid crystal display panel 110A and the light shielding film 150 of the liquid crystal display panel 110B.

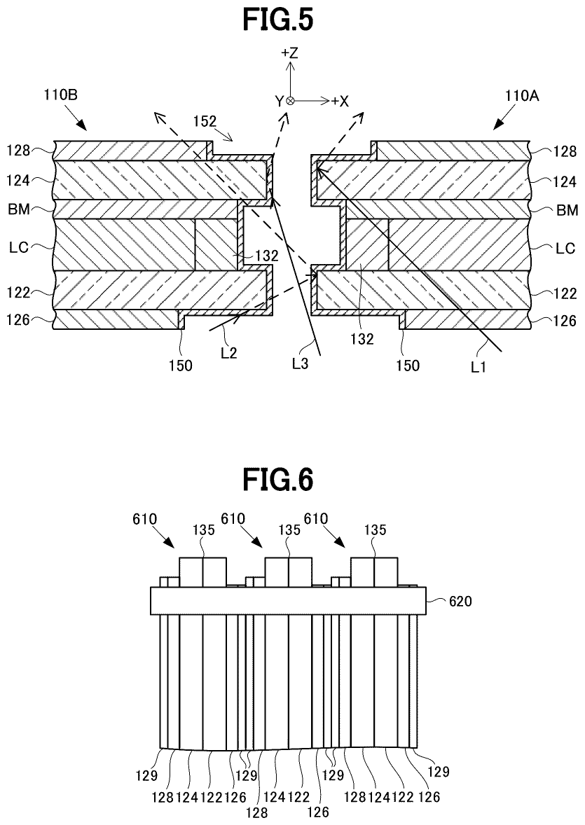

The light shielding film 150 blocks the light from the back light 200. In one example, the light shielding film 150 absorbs the light from the back light 200. Specifically, as illustrated in FIG. 5, the light shielding film 150 blocks, of the light from the back light 200, light L1 that enters the liquid crystal display panel 110A (the liquid crystal display panel 110B), reflects at an interface between a side surface of the counter substrate 124 (the TFT substrate 122) and the gap 152 (air layer), and exits to the observer side. Additionally, the light shielding film 150 blocks, of the light from the back light 200, light L2 that exits from the TFT substrate 122 of the liquid crystal display panel 110B (the liquid crystal display panel 110A), reflects at the side surface of the TFT substrate 122 of the liquid crystal display panel 110A (the liquid crystal display panel 110B), enters again into the liquid crystal display panel 110B (the liquid crystal display panel 110A), and exits to the observer side from the liquid crystal display panel 110B (the liquid crystal display panel 110A). Furthermore, the light shielding film 150 blocks, of the light from the back light 200, light L3 that reflects at the side surface of the counter substrate 124 (the TFT substrate 122) in the gap 152 and exits to the observer side without entering the liquid crystal display panel 110A and the liquid crystal display panel 110B. As a result, the light shielding film 150 can suppress light leakage from the liquid crystal display device 10. Additionally, the light shielding film 150 is provided on each of the side surfaces 135, that oppose each other, of the liquid crystal display panel 110A and the liquid crystal display panel 110B and, as such, it is possible to make a spacing S1 (FIG. 3) of the liquid crystal display panel 110A and the liquid crystal display panel 110B extremely narrow.

The light shielding film 150 is implemented as a blackening film formed from a metal oxide, a black coating film formed from black paint, or the like. In one example, the light shielding film 150 is formed, by sputtering, from a metal oxide. As illustrated in FIG. 6, the light shielding film 150 can be formed by clamping a plurality of liquid crystal display panels 610, in a state in which a protection film 129 is affixed to the incident side polarizing plate 126 and the exit side polarizing plate 128, in a jig 620, and forming a blackening film on the side surfaces 135. In one example, a thickness of the light shielding film 150 is from 35 nm to 50 nm. Note that the sealing material 132 and the like are omitted from FIG. 6. Additionally, the protection film 129 is removed after the light shielding film 150 is formed.

As illustrated in FIG. 2, the back light 200 of the display 100 is disposed on a back side (−Z side) of the liquid crystal display panels 110A, 110B. The back light 200 is the light source of the liquid crystal display panels 110A, 110B. The back light 200 emits white light toward the liquid crystal display panels 110A, 110B. The back light 200 includes a white light emitting diode (LED) element, a reflecting sheet, a diffusing sheet, a lighting circuit, and the like (all not illustrated in the drawings).

The housing 230 of the display 100 accommodates the liquid crystal display panels 110A, 110B and the back light 200. The housing 230 includes a chassis 232 and a bezel 236.

The chassis 232 has a box-like shape. The chassis 232 is formed from a resin or a metal. The chassis 232 accommodates, therein, the liquid crystal display panels 110A, 110B and the back light 200.

The bezel 236 has a box-like shape and includes an opening in a bottom 237 thereof. In one example, the bezel 236 is formed from a metal. The bezel 236 covers the chassis 232 with the bottom 237 facing the +Z side. The liquid crystal display panels 110A, 110B are exposed through the opening. In the present embodiment, a side plate 239 of the bezel 236 is adhered, by a non-illustrated adhesive, to an inner wall 510a of the opening 510 of the instrument panel 500. As a result, the liquid crystal display device 10 is fixed to the opening 510 of the instrument panel 500.

As illustrated in FIG. 2, the protector 300 of the liquid crystal display device 10 is provided on a display surface (+Z side surface) 113 of the liquid crystal display panels 110A, 110B. The protector 300 protects the liquid crystal display panels 110A, 110B. In one example, the protector 300 is formed in a rectangular shape from a light-transmitting resin. The protector 300 is affixed to the display surface 113 of the liquid crystal display panels 110A, 110B by an adhesive 320. In one example, the adhesive 320 is implemented as an optical clear adhesive (OCA).

When viewed from above, the protector 300 includes a light shield 302 that covers the gap 152 between the liquid crystal display panel 110A and the liquid crystal display panel 110B. In one example, the light shield 302 is formed from black ink. The light shield 302 blocks the light that exits to the observer side through the gap 152 between the liquid crystal display panel 110A and the liquid crystal display panel 110B. Accordingly, the liquid crystal display device 10 can further suppress light leakage.

As described above, the light shielding film 150 that blocks the light from the back light 200 is provided on each of the side surfaces 135, that oppose each other, of the liquid crystal display panel 110A and the liquid crystal display panel 110B and, as such, the liquid crystal display device 10 can suppress light leakage. Additionally, it is possible to make the spacing of the liquid crystal display panel 110A and the liquid crystal display panel 110B extremely narrow, and the displaying of the liquid crystal display panel 110A and the displaying of the liquid crystal display panel 110B can be provided with a sense of unity. Furthermore, the light shield 302 of the protector 300 covers the gap 152 between the liquid crystal display panel 110A and the liquid crystal display panel 110B and, as such, the liquid crystal display device 10 can further suppress light leakage.

### Embodiment 2

In Embodiment 1, the gap 152 is formed between the liquid crystal display panel 110A and the liquid crystal display panel 110B. Additionally, the protector 300 includes the light shield 302 that covers the gap 152. A configuration is possible in which a portion of the gap 152 is filled in by a joint filling member. A configuration is also possible in which the protector 300 does not include the light shield 302.

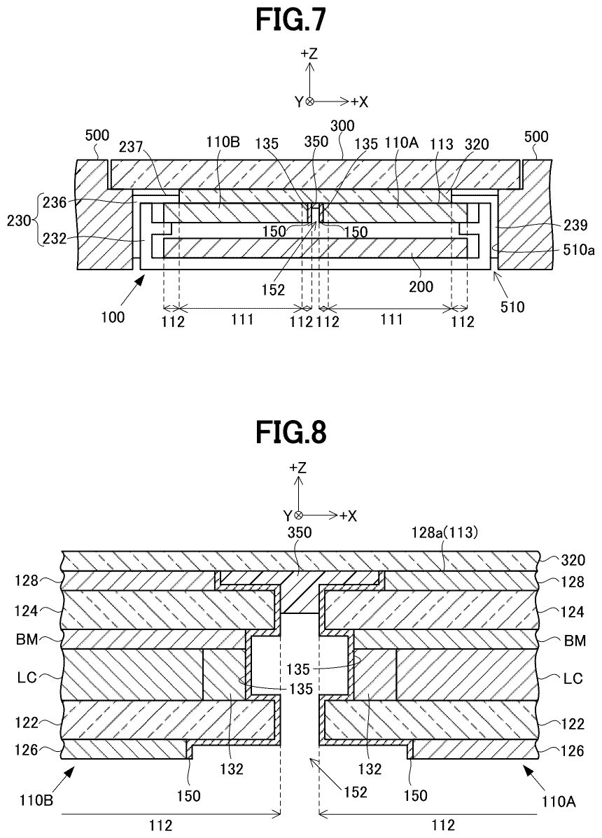

As with the liquid crystal display device 10 of Embodiment 1, the liquid crystal display device 10 of the present embodiment includes a display 100 and a protector 300. Additionally, the display 100 includes two liquid crystal display panels 110A, 110B, a back light 200, and a housing 230. In the present embodiment, as illustrated in FIGS. 7 and 8, the display 100 further includes a joint filler 350.

In the present embodiment, aside from the protector 300 not including a light shield 302, and the display 100 including the joint filler 350, the configuration of the liquid crystal display device 10 (the configurations of the liquid crystal display panels 110A, 110B, the back light 200, and the like) is the same as in Embodiment 1. As such, the joint filler 350 of the display 100 is described next.

The joint filler 350 fills in a portion of the gap 152 between the liquid crystal display panel 110A and the liquid crystal display panel 110B. In the present embodiment, the joint filler 350 fills in a portion on the observer side of the gap 152.

The joint filler 350 has light shielding properties. The joint filler 350 that has light shielding properties fills in a portion of the gap 152 and, as such, the liquid crystal display device 10 of the present embodiment can block the light that exits to the observer side through the gap 152 without the light shield 302 being provided on the protector 300. Additionally, the protector 300 does not include the light shield 302 and, as such, the displaying of the liquid crystal display panel 110A and the displaying of the liquid crystal display panel 110B can be provided with a sense of unity.

In one example, the joint filler 350 is formed from a carbon black-containing acrylic adhesive. In one example, the joint filler 350 is formed by pouring the carbon black-containing acrylic adhesive into the gap 152 and, then, curing the carbon black-containing acrylic adhesive. In the present embodiment, the joint filler 350 that has light shielding properties fills in a portion of the gap 152 between the liquid crystal display panel 110A and the liquid crystal display panel 110B and, as such, the light that exits to the observer side through the gap 152 can be blocked. Additionally, the light that exits to the observer side through the gap 152 can be blocked without the light shield 302 being provided on the protector 300 and, as such, the displaying of the liquid crystal display panel 110A and the displaying of the liquid crystal display panel 110B can be provided with a sense of unity. Furthermore, as in Embodiment 1, the light shielding film 150 that blocks the light from the back light 200 is provided on each of the side surfaces 135, that oppose each other, of the liquid crystal display panel 110A and the liquid crystal display panel 110B and, as such, the liquid crystal display device 10 can suppress light leakage and it is possible to make the spacing of the liquid crystal display panel 110A and the liquid crystal display panel 110B extremely narrow.

### Embodiment 3

In Embodiment 2, the liquid crystal display panel 110A and the liquid crystal display panel 110B each include an exit side polarizing plate 128. However, a configuration is possible in which the liquid crystal display panel 110A and the liquid crystal display panel 110B share an exit side polarizing plate 128.

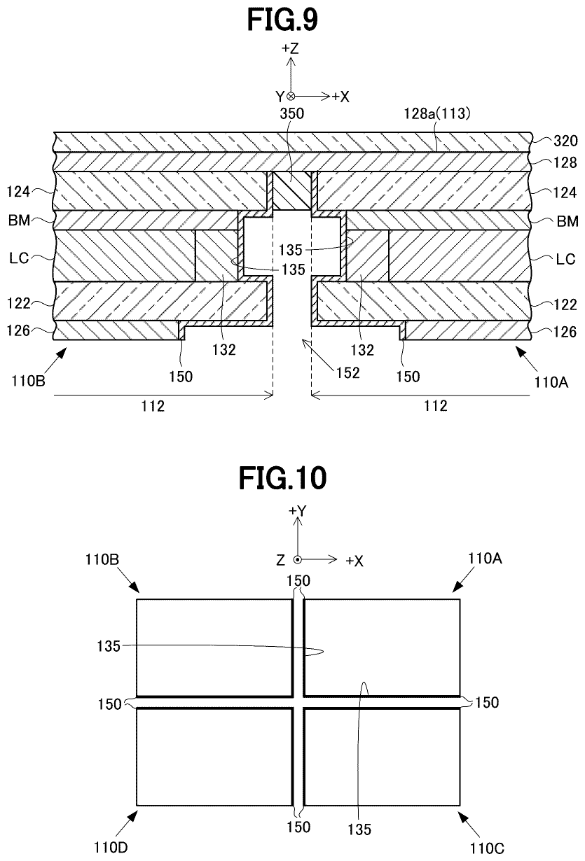

In the present embodiment, as illustrated in FIG. 9, the liquid crystal display panel 110A and the liquid crystal display panel 110B share one exit side polarizing plate 128. Additionally, the joint filler 350 is provided on the gap 152 on the side (−Z side), of the exit side polarizing plate 128, opposite the observer (for example, between the counter substrate 124 of the liquid crystal display panel 110A and the counter substrate 124 of the liquid crystal display panel 110B). The other configurations of the liquid crystal display device 10 of the present embodiment are the same as in Embodiment 2.

In the present embodiment, the liquid crystal display panel 110A and the liquid crystal display panel 110B share one exit side polarizing plate 128, and the joint filler 350 is positioned on the side (the −Z side), of the exit side polarizing plate 128, opposite the observer. As such, the reflectance of the liquid crystal display device 10 to external light becomes uniform. As a result, with the liquid crystal display device 10 of the present embodiment, the joint filler 350 (the gap 152) can be made less noticeable.

As described above, the liquid crystal display panel 110A and the liquid crystal display panel 110B share one exit side polarizing plate 128, and the joint filler 350 is positioned on the side (the −Z side), of the exit side polarizing plate 128, opposite the observer. As such, the joint filler 350 can be made less noticeable. Additionally, as in Embodiment 1, the liquid crystal display device 10 can suppress light leakage, and it is possible to make the spacing of the liquid crystal display panel 110A and the liquid crystal display panel 110B extremely narrow.

### Modified Examples

Embodiments have been described, but various modifications can be made to the present disclosure without departing from the spirit and scope of the present disclosure.

For example, a configuration is possible in which the display 100 of the liquid crystal display device 10 includes a plurality of back lights 200.

A configuration is possible in which the light shielding film 150 extends to the display surface 113 of the liquid crystal display panels 110A, 110B. Additionally, a configuration is possible in which the light shielding film 150 is formed by spray coating black paint. When forming the light shielding film 150, the exposed terminals, wirings, and the like of the liquid crystal display panels 110A, 110B may be masked.

In Embodiments 1 to 3, the light shielding film 150 covers all of the side surfaces 135 of the liquid crystal display panels 110A, 110B. However, it is sufficient that the light shielding film 150 covers at least a portion of the side surfaces 135. For example, a configuration is possible in which the light shielding film 150 does not cover all or a portion of the main surfaces 122a, 122b of the TFT substrate 122, the main surfaces 124a, 124b of the counter substrate 124, the side surface 132c of the sealing material 132, and the side surface BMc of the black matrix BM that are exposed at the side of the liquid crystal display panel 110A. It is preferable that the light shielding film 150 covers the side surface 122c of the TFT substrate 122 and the side surface 124c of the counter substrate 124.

In Embodiments 1 to 3, the liquid crystal display device 10 includes the two liquid crystal display panels 110A, 110B. However, it is sufficient that the liquid crystal display device 10 includes a plurality of liquid crystal display panels. For example, a configuration is possible in which the liquid crystal display device 10 includes four liquid crystal display panels 110A to 110D. In such a case, as illustrated in FIG. 10, a configuration is possible in which each of the liquid crystal display panels 110A to 110D includes the light shielding film 150 on two side surfaces 135 that oppose the side surfaces 135 of the adjacent liquid crystal display panels 110A to 110D.

Additionally, a configuration is possible in which at least two of the liquid crystal display panels 110A to 110D that are adjacent share one exit side polarizing plate 128.

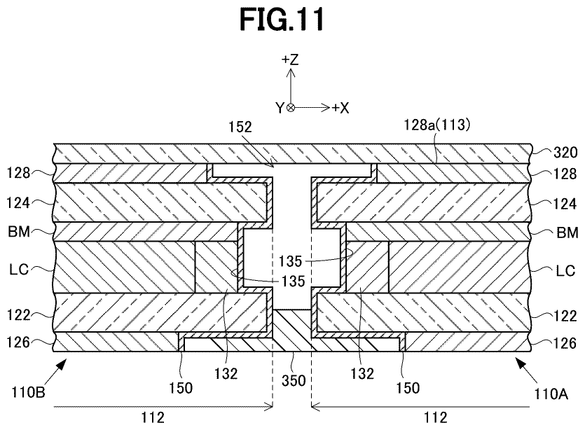

In Embodiments 2 and 3, the joint filler 350 fills in a portion on the observer side of the gap 152. However, a configuration is possible in which, as illustrated in FIG. 11, the joint filler 350 fills in a portion on the back light 200 side of the gap 152.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A liquid crystal display device comprising:
a juxtaposed plurality of liquid crystal display panels; and
a back light that emits light on the plurality of liquid crystal display panels, wherein
each of the plurality of liquid crystal display panels includes, on a side surface opposing a side surface of the liquid crystal display panel adjacent thereto, a light shielding film that blocks the light from the back light.

2. The liquid crystal display device according to claim 1, further comprising:
a protector disposed on a display surface side of the plurality of liquid crystal display panels, wherein
the protector includes a light shield that covers a gap between, of the plurality of liquid crystal display panels, one liquid crystal display panel and a liquid crystal display panel adjacent to the one liquid crystal display panel.

3. The liquid crystal display device according to claim 1, further comprising:
a joint filler that has light shielding properties and that fills in a portion of a gap between, of the plurality of liquid crystal display panels, one liquid crystal display panel and a liquid crystal display panel adjacent to the one liquid crystal display panel.

4. The liquid crystal display device according to claim 3, wherein at least two of the liquid crystal display panels that are adjacent share one exit side polarizing plate.
